(19) United States
(12) Patent Application Publication
(10) Pub. No.: US 2010/0170549 A1
(43) Pub. Date: Jul. 8, 2010

(54) Ground Sheet Arrangement for a Structure

(75) Inventors: Geoffrey Ian Bell, Bournemouth (GB); Franziska Conrad, Bournemouth (GB)

Correspondence Address: RANKIN, HILL & CLARK LLP, 38210 Glenn Avenue, WILLOUGHBY, OH, 44094-7808, US

(73) Assignee: BU INNOVATIONS LTD., Bournemouth, Dorset (GB)

(21) Appl. No.: 12/663,062

(22) PCT Filed: Jun. 5, 2008
(86) PCT No.: PCT/GB08/01924

§ 371 Date: Mar. 2, 2010

(30) Foreign Application Priority Data
Jun. 5, 2007 (GB) 0710740.2

(51) Int. Cl. E04H 15/56; B32B 3/10; B32B 5/02

(52) U.S. Cl. 135/116; 428/131; 428/195.1; 428/196

(57) ABSTRACT

The invention provides a ground sheet arrangement for enclosures wherein an outer ground sheet is capable of allowing condensate from inner surfaces of the enclosure to drain away from the base of the enclosure, and also provides for alternate means for securing an inner ground sheet within an outer ground sheet of the enclosure.

### FIELD OF THE INVENTION

The present invention relates to a ground sheet arrangement for a structure to which one or more ground sheets are attached to form a base for the structure. The structure may be a fabric structure such as a tent made from a flexible materials, that can form an enclosure for housing people or any other article.

### BACKGROUND OF THE INVENTION

As is well known, there are available a variety of fabric structures such as tents which are fitted with ground sheets. The ground sheets may be free fitting or sewn into the flexible fabric of the tent where it is desired to provide an improved resistance to water ingress.

In the case of some types of pop-up tents, the ground sheets may also be a structural component in that they hold the frame in a particular shape. With single skinned pop-up tents the ground sheet is sewn into place and holds the lower frame hoop into its elongated circular shape. If it were not, the lower frame hoop would take on its natural circular shape.

However, single skinned tents have drawbacks in that there is nowhere to store wet clothing or other necessary camping equipment other than in the same space as the sleeping area. In addition, under certain cool and/or damp conditions, condensation can form on the inside face of the tent fabric. This then tends to run down the tent fabric forming pools of water on the ground sheet or drips off the tent onto the occupier. Both lead to damp uncomfortable bedding, clothing and camping equipment.

Accordingly, it has been customary to incorporate a separate inner tent made of a breathable fabric which is held in place inside an outer water proof tent via flexible straps attached to a frame at the top and sides and to peg an inner ground sheet i.e., ground sheet of the inner tent, to the ground at the base to locate it. Such an arrangement of an outer and inner tent is seen is FIGS. 2 and 3. In general, the inner tent is fitted with a sewn in ground sheet and the outer space is fitted with a separate outer ground sheet. Condensate accumulating on the outer tent fabric either runs down the tent walls and soaks away into the ground below or drops onto the inner tent and is deflected down the outside of its walls protecting the occupants and goods stored inside it.

In the case of pop-up tent designs however, where the lower frame hoop is retained in shape by the ground sheet of the outer tent fabric, condensate running down the walls has nowhere to drain away and collects on the inside of such a ‘bath tub’ type ground sheet arrangement. Such a tent can be seen in FIG. 1. In addition, the inner tent cannot be secured at the base via pegs into the ground as the outer tent ground sheet in the way. If the inner tent is directly attached to the ground sheet of the outer tent, goods stored in the outer compartment are exposed to pools of condensate collecting on the ground sheet in the space between the inner and outer tents causing dampness in the living space of the tent. If the inner tent only has a ground sheet and this is secured to the lower hoops of the frame via straps, the condensate can drain away but insects can enter the space between the inner and outer tent skins.

The present invention aims to provide solutions to the drawbacks of these known ground sheet arrangements for tents.

### SUMMARY OF THE INVENTION

In accordance with a first embodiment, the invention provides a ground sheet arrangement for a structure, said structure being arranged to form an enclosure having a top surface and side surfaces, such that said ground sheet arrangement forms a base for the enclosure, the arrangement comprising a water-proof ground sheet having a plurality of openings cut out from its fabric thereby providing means for allowing condensate from the inner surfaces of the structure to drain into ground below said structure without collecting on the ground sheet.

Alternately, the above-mentioned openings may be replaced with areas comprised of a permeable material. These permeable areas may be continuous or discontinuous.

In accordance with a second embodiment, the invention provides a ground sheet arrangement for a structure having an outer housing provided with an outer ground sheet and an inner housing provided with an inner ground sheet, said outer ground sheet being attached to a lower frame of the structure, wherein said ground sheet arrangement comprises securing means for removably securing one or more edges of the inner ground sheet to the outer ground sheet such that the inner ground sheet is positioned above the outer ground sheet.

Alternately, the inner and outer ground sheets are bonded together at the edges of the inner ground sheet.

### BRIEF DESCRIPTIONS OF THE DRAWINGS

In order to facilitate the understanding of this invention the concept will be described with reference to the accompanying drawings:

FIG. 1 shows by way of example a schematic perspective of a typical pop-up tent in which this invention may be used.

FIG. 2 shows an outline of a tent having an outer and inner tent section, with the typical flexible fixing straps used for holding the inner tent to the tent frame.

FIG. 3 shows a sectioned view of the typical pop-up tent of FIG. 1 in which this invention may be used.

FIG. 4 shows an outline of a ground sheet in accordance with a first embodiment of the present invention.

FIG. 5 shows a ground sheet in accordance with an alternate aspect of the first embodiment of the invention.

FIG. 6 shows a sectional side view of an inner and outer tent arrangement so fitted with ground sheet(s) according to the first embodiment of the present invention.

FIG. 7 shows an inner ground sheet fixed to an outer ground sheet, in accordance with a second embodiment of the invention.

FIG. 8 shows a means of securing an inner ground sheet to an outer structure, in accordance an alternate aspect of the second embodiment.

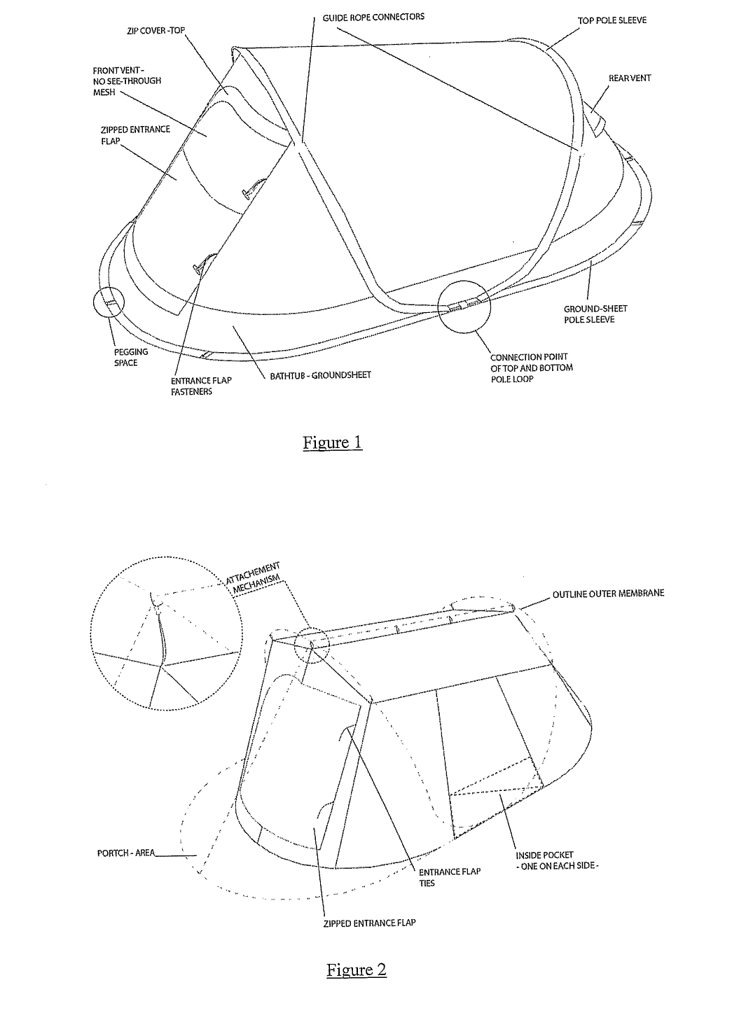

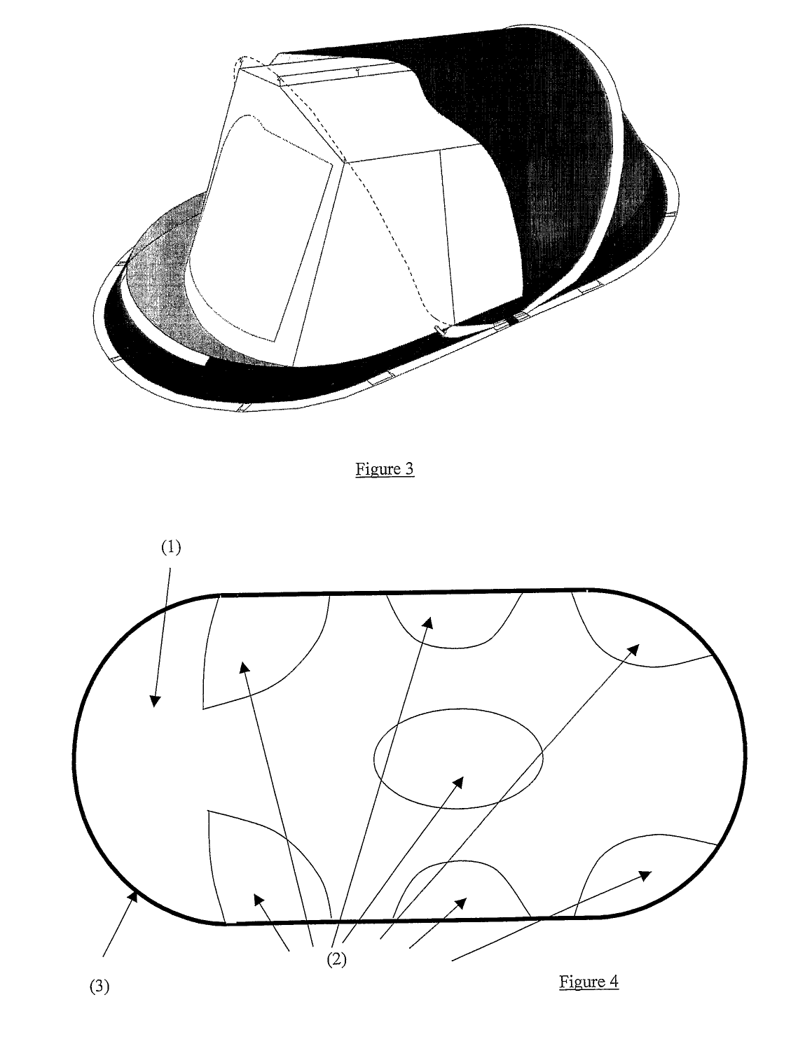

### DETAILED DESCRIPTION OF THE EMBODIMENTS

In a first embodiment, the present invention provides means for allowing condensate to drain away from the ground sheets of a structure, thereby ensuring that water does not collect inside the structure. The ground sheets may be fitted to fabric structures such as pop-up tents, frame tents, ridge tents and inflatable tents etc., or any other flexible or collapsible temporary enclosure or housing.

A second embodiment of the present invention provides means for securing an inner ground sheet to an outer ground sheet of a structure. More specifically, the second embodiment provides for a fabric structure arrangement wherein it may be the case that a lower frame of the structure is retained in its shape by the outer ground sheet, thereby making it difficult for a ground sheet of an inner housing to be secured to the floor, since the outer ground sheet is a continuous structure.

The invention will be described hereinafter as being implemented for fabric tents. However, the invention is not restricted for use with tents alone and is to be understood as being suitable for use in any structure serving the purpose of a temporary or collapsible enclosure suitable for housing people or articles, either indoor or outdoors. According to the first embodiment of the invention as shown in FIG. 4, a plurality of cut-outs (2) or openings (2), are inserted in positions in the fabric of the ground sheet (1) adjacent to the walls of the tent fabric so that any condensate running down the walls can pass through the ground sheet into the ground below. At the same time, as in most cases the cuts outs (2) are perceived to be discontinuous, the ground sheet can provide structural support in the case where it also has to act as a stiffening membrane to a lower frame member (3) of the fabric structure, thereby holding a shape for the frame (3). This aspect of the invention can be used for fabric structures with one or more skins.

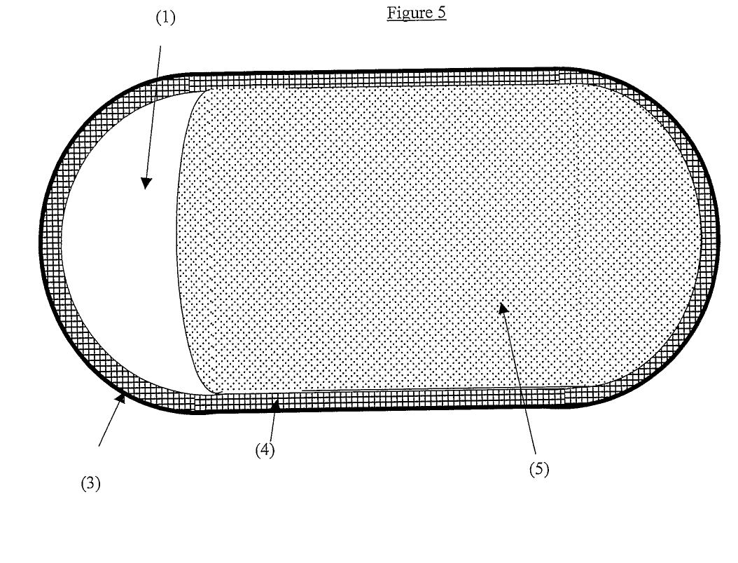

Alternately, the ground sheet of the first embodiment may comprise some regions of waterproof membrane and some regions of fabric through which water can pass, such as a permeable membrane in the form of a mesh (4). FIG. 5 shows an outline of a ground sheet (1) with a mesh (4) so fitted to allow the condensate to drain through into the ground below. A waterproof ground sheet for an inner tent section (5) may be also integrated with ground sheet (1), which is the outer tent's ground sheet, or can be separate from it. The mesh (4) is inserted either within cut out regions of the waterproof membrane, as described in the first aspect of the invention, or can be a continuous area placed near the edge of the ground sheet (1). The mesh is arranged at points in the ground sheet where water can collect such as around the sidewalls of the tent. Any stresses in the ground sheet are evenly distributed throughout the ground sheet (1), which will prove useful for pop-up tents wherein the ground sheet is a structural component which dictates the shape that the lower frame (3) of the tent takes. In addition, insects will not gain access into the living space of a single skinned tent, or the inner tent or outer chamber of a double skinned tent arrangement. This aspect of the invention can also be used for fabric structures with one or more skins.

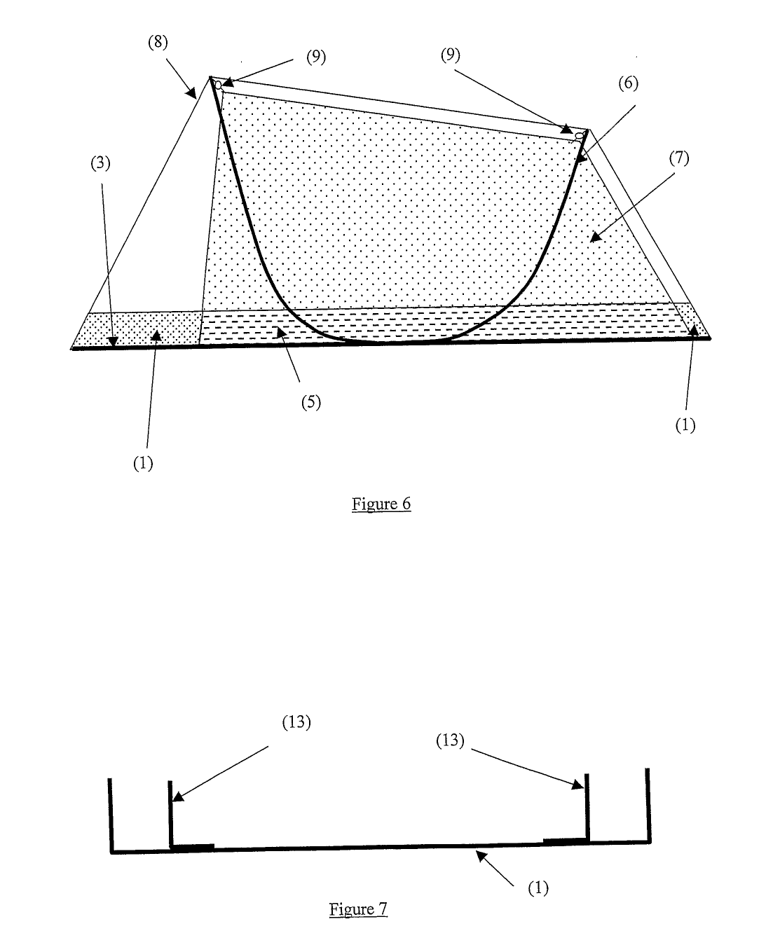

A sectional view of such an inner and outer tent arrangement so fitted with ground sheets according to the first embodiment described above can be seen in FIG. 6. Here outer tent (8) is held up by upper or ‘saddle’ hoop of frame (6). The inner tent (7) is supported by flexible fixing straps (9) connected either to an upper or ‘saddle’ hoop of frame (6) or the outer tent (8). The waterproof ground sheet (1) for the outer tent runs upwards on the outer tent (8). The waterproof ground sheet (5) for the inner tent is shown runs upwards on the inner tent (7). The outer ground sheet (1) can be provided with either cut-outs (2) or a mesh (4) according to the first embodiment of the invention.

Single skinned pop-up tent arrangements, wherein ground sheet (1) acts as a support member for a lower frame (3) of the tent can also be fitted with ground sheets according to the first embodiment.

According to the second embodiment of the invention, means for securing the inner tent ground sheet to the outer tent ground sheet of a pop-up tent are provided. As mentioned previously, this embodiment provides for a fabric structures wherein it may be the case that a lower frame of the structure is retained in its shape by the outer ground sheet, thereby making it difficult for a ground sheet of an inner housing to be secured to the floor. Therefore, for these tents, it would have not been possible to have an inner tent within the fabric structure, since the base of such inner tent will not be able to be secured to the ground as it can be for other types of tent arrangements.

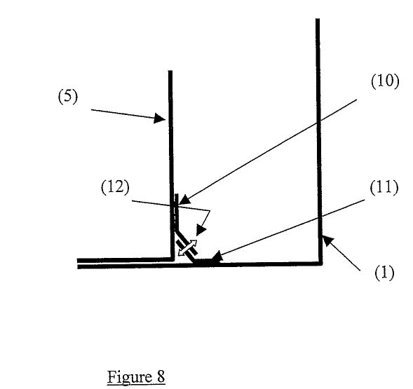

In an aspect of the second embodiment as shown in FIG. 7, the ground sheets of the outer and inner tents are combined with each other thereby fixing the position of the inner tent and removing the need for separate base location straps to locate the inner tent ground sheet. FIG. 7 shows the inner ground sheet's edges (13) bonded to the outer tents ground sheet (1) to secure the inner tent in position. As shown in this figure, it may be that inner tent's ground sheet is discontinuous, comprising of only edges (13) which are bonded to the outer tent ground sheet (1). This results in the combination of both ground sheets to form a single sheet of material, which acts as a common single-skinned ground sheet (1) for the tent arrangement. Such an arrangement has an advantage of reducing the amount of material used for making up the ground sheet arrangement for such a tent. This in turn reduces manufacturing cost of the tent and makes its assembly easy to use. This embodiment also allows for the possibility fixing both the inner and outer ground sheets to each other, wherein the inner tent's ground sheet is continuous, thereby resulting in a double skinned ground sheet with the base of both ground sheets combined with each other. Here the inner ground sheet is arranged on top of the outer ground sheet and bonded to the outer sheet (1).

Alternately, the ground sheet of the inner tent (5) of the second embodiment may be fastened to the ground sheet of the outer tent to fix its position, as shown in FIG. 8. This enables the inner tent to be manufactured separately if required or replaced if damaged. The inner and outer ground sheets may be secured together via the use of sewn in tabs with eyelets fitted to both ground sheets and cords to secure them. Alternate methods such as zips, Velcro®, or clasps may also be used. In FIG. 8, a partial view of a means of the fixing of the inner ground sheet (5) to the outer ground sheet (1) is shown using location tabs (10 & 11) and a coupling means (12) such as a proprietary coupling. This is especially suitable for cases where one ground sheet needs to be secured in position on top of another and where the distances between the inner tent and the lower frame are large; avoiding the need for long ties.

Therefore, the second embodiment provides for securing an inner ground sheet to the outer ground sheet, which is in turn attached to a lower frame (3) of the structure to provide support for the fabric structure. Therefore, once the inner tent's ground sheet has been so secured, cut-outs or permeable membranes can be incorporated in the outer ground sheet as described in the first embodiment for allowing condensate to drain into the floor instead of collecting on the outer ground sheet of the tent.

1. A ground sheet arrangement for a structure, said structure being arranged to form an enclosure having a top surface and side surfaces, such that said ground sheet arrangement forms a base for the enclosure when the structure is placed on the ground, the arrangement comprising a water-proof ground sheet (1) having a plurality of openings (2) cut out from its fabric thereby providing means for allowing condensate from the inner surfaces of the structure to drain into ground below said structure through said openings (2), without collecting on the ground sheet (1).

2. The ground sheet arrangement as claimed in claim 1, wherein said plurality of openings (2) in the ground sheet (1) are located adjacent to the side surfaces of the structure (1).

3. A ground sheet arrangement for a structure, said structure being arranged to form an enclosure having a top surface and side surfaces, such that said ground sheet arrangement forms a base for the enclosure when the structure is placed on the ground, the arrangement comprising a water-proof ground sheet (1) provided with one or more areas formed of a permeable material, said one or more areas providing means for allowing condensate from the inner surfaces of the structure to drain into ground below said structure through said areas of permeable material on the ground sheet (1) without collecting on the ground sheet (1).

4. The ground sheet arrangement as claimed in claim 3, wherein said permeable material is a mesh arrangement (4).

5. The ground sheet arrangement as claimed in claim 4 wherein said mesh arrangement (4) is discontinuous such that it is provided within a plurality of areas cut out from the ground sheet (1), said cut out areas being located adjacent to the side surfaces of the structure.

6. The ground sheet arrangement as claimed in claim 4 wherein said mesh arrangement (4) forms a continuous area provided near the outer edge of the ground sheet (1) and located adjacent to the side surfaces of the structure.

7. (canceled)

8. (canceled)

9. (canceled)

10. (canceled)

11. (canceled)

12. (canceled)

13. (canceled)

14. (canceled)

15. (canceled)

16. (canceled)

17. The ground sheet arrangement as claimed in claim 1 wherein said structure is a fabric structure made from a flexible material.

18. The ground sheet arrangement as claimed claim 17 wherein said fabric structure is a tent having one or more skins.

19. The ground sheet arrangement as claimed in claim 17 wherein said fabric structure is a tent arrangement having an inner tent (7) placed within an outer tent (8), the inner tent (7) having a water proof inner ground sheet (5), said outer tent (8) being provided with ground sheet (1) whereby condensate from inner surfaces of the structure is drained into the ground below the structure from the ground sheet (1) of the outer tent.

20. The ground sheet arrangement as claimed in claim 3 wherein said structure is a fabric structure made from a flexible material.

21. The ground sheet arrangement as claimed claim 20 wherein said fabric structure is a tent having one or more skins.

22. The ground sheet arrangement as claimed in claim 20 wherein said fabric structure is a tent arrangement having an inner tent (7) placed within an outer tent (8), the inner tent (7) having a water proof inner ground sheet (5), said outer tent (8) being provided with ground sheet (1) whereby condensate from inner surfaces of the structure is drained into the ground below the structure from the ground sheet (1) of the outer tent.
